(19) United States
(12) Patent Application Publication
(10) Pub. No.: US 2023/0054360 A1
(43) Pub. Date: Feb. 23, 2023

(54) MACHINE LEARNING CONSOLIDATION

(71) Applicant: Raytheon Company, Waltham, MA (US)

(72) Inventor: John E. Mixter, Tucson, AZ (US)

(21) Appl. No.: 17/404,707

(22) Filed: Aug. 17, 2021

(51) Int. Cl. G06N 3/08; G06N 20/10; G06N 3/04

(52) U.S. Cl. CPC G06N 3/08; G06N 20/10; G06N 3/04

(57) ABSTRACT

A machine learning system identifies functions that have similar weighted values, and the system determines a representative weighted value for these functions. The system then calculates a summation of the input values for the functions, and multiplies the summation by the representative weighted value, which generates an output for the functions.

### TECHNICAL FIELD

Embodiments described herein generally relate to reducing the resources that are required in the execution of a machine learning algorithm, and in a particular embodiment, but not by way of limitation, consolidating synaptic inputs in an artificial neural network or similar machine learning algorithm.

### BACKGROUND

One of the major roadblocks of executing neural networks on certain systems, such as in low SWaP (size, weight, and power) embedded hardware, is the resources required, such as memory, computational power, and timing.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 illustrates a plurality of synapses in an artificial neural network.

FIG. 2 illustrates an embodiment of consolidating synapses in an artificial neural network.

FIG. 3 is a block diagram illustrating an embodiment of a process for machine learning consolidation.

FIGS. 4A, 4B, and 4C are a block diagram illustrating another embodiment of a process for machine learning consolidation.

FIG. 5 is a block diagram illustrating a computer system upon which one or more embodiments of the present disclosure can execute.

### DETAILED DESCRIPTION

An embodiment of the present disclosure reduces the calculations required to perform a classification in an artificial neural network or similar machine learning algorithm. Specifically, execution of a neural network requires many multiply and accumulate operations (i.e., weights×inputs). Because multiplication is more expensive than addition in terms of cycles per instruction, any reduction in the number of multiplications will significantly reduce the neural network execution time. Embodiments of the present disclosure replace expensive multiplications with additions, which require fewer cycle to execute. A byproduct of these embodiments is a significant reduction in the amount of memory and bandwidth needed to execute the neural network.

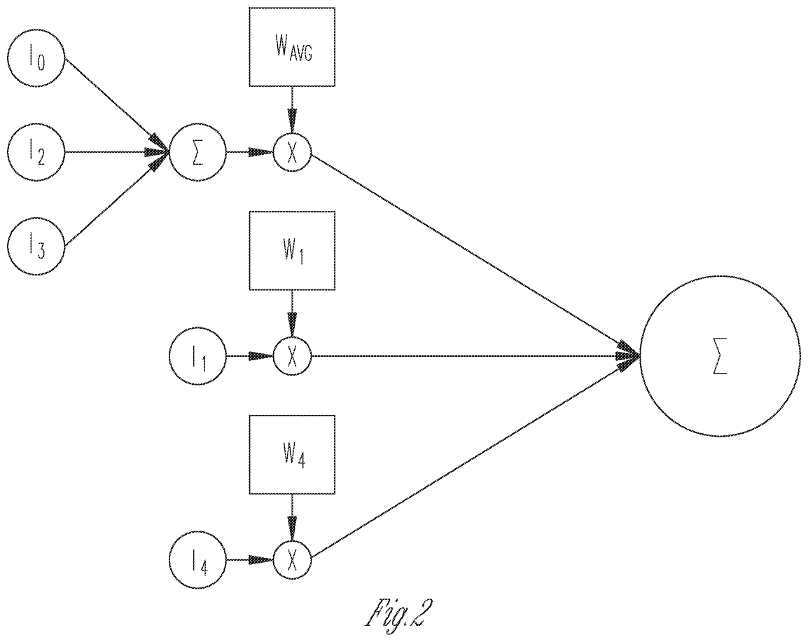

In an embodiment, synaptic input consolidation reduces the number of these multiplications needed by finding inputs with similar weight values, adding the input values together and multiplying the sum by a single representative weight value. For each perceptron in a trained dense layer, the weights can be clustered using a 1D k-means algorithm. Each weight that is associated with the perceptron is checked to see to which cluster it belongs. When the correct cluster is found for a given weight, the neural network architecture is modified (see FIG. 2), and the input associated with the weight is summed (via an add function for each cluster) with other inputs that belong to the same cluster and the weight is removed. After all the weights have been removed, the sum of each cluster is multiplied by the average weight value of that cluster. This is repeated for each perceptron in the dense layers by passing the product for each cluster to the respective connected perceptron and normal forward propagation continues.

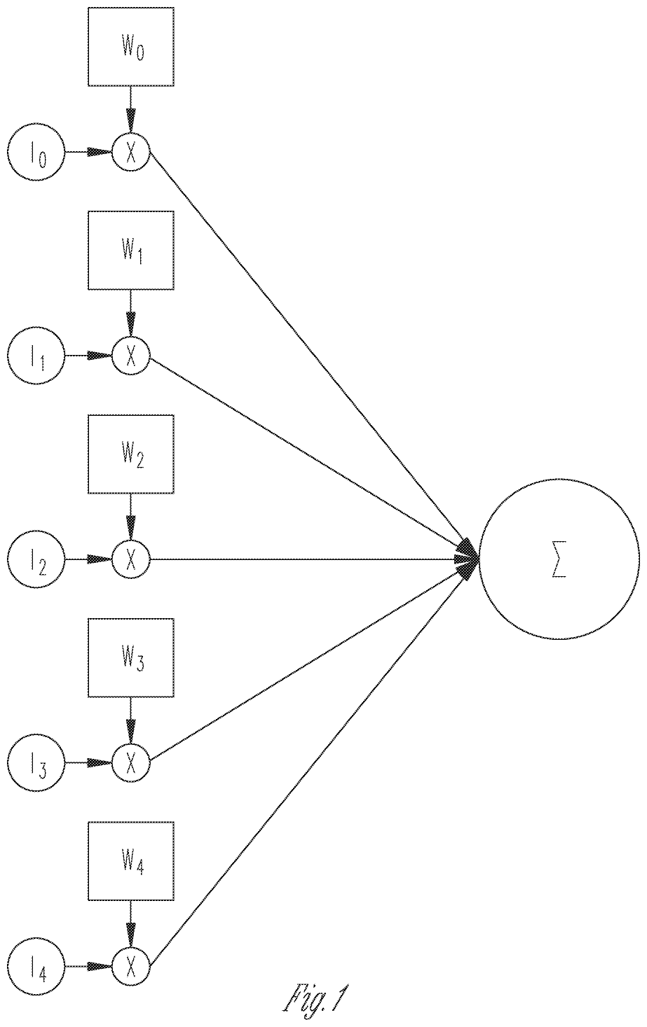

Referring now to FIG. 1, as noted, perceptrons normally multiply weights by input values and sum the results.

Y=I₀W₀+I₁W₁+I₂W₂+I₃W₃+I₄W₄

If W₀≈W₂≈W₃, then the following change can be made:

Change Y=I₀W₀+I₁W₁+I₂W₂+I₃W₃+I₄W₄ to Y=(I₀+I₂+I₃)W_{avg}+I₁W₁+I₄W₄

wherein W_{avg}=The average of W₀, W₂ and W₃

The resulting synaptic structure is illustrated in FIG. 2. It is noted that the perceptron illustrated in FIG. 1 require five multiplications and five additions, whereas the perceptrons illustrated in FIG. 2 require only three multiplications and five additions. In artificial neural networks that include thousands of perceptrons, such differentials can amount to substantial savings in processing cycles and memory usage.

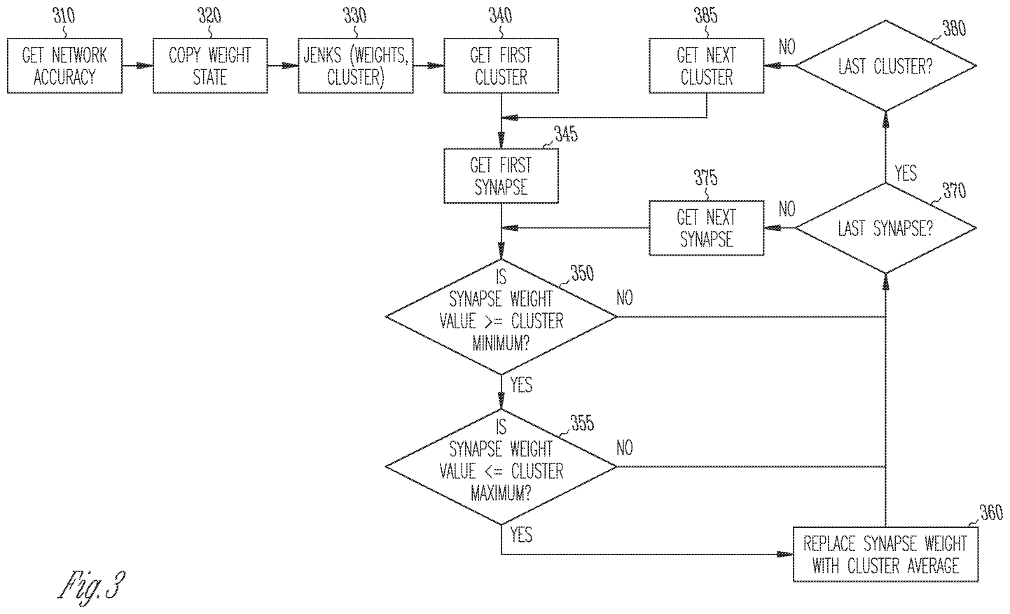

To find weight values that are approximately the same, a Jenks optimization algorithm can be used. The Jenks algorithm reduces the variance within a group of weights and maximizes the variance between groups of weights. The process is illustrated in FIG. 3.

Specifically, referring to FIG. 3, at 310 a current accuracy of the artificial neural network is retrieved. This accuracy was previously determined using known methods in the art, and it is used to verify that the accuracy of the neural network has not appreciably diminished after the synapse consolidation. At 320, the state of the neural network and the current weights that are associated with the neural network are copy and saved. This permits an operator to return to the original state of the neural network if an acceptable accuracy cannot be maintained in the consolidation of the synapses.

At 330, the process continues with a clustering of the weights of the synapses in the layer at issue in the neural network. In an embodiment, a range of the weights in the perceptrons in the layer at issue is determined (that is, a range from the minimum weight value to the maximum weight value). That range is then used to generate two distinct clusters.

At 340, the first cluster is obtained, and at 345, the first synapse in that first cluster is retrieved. At 350, it is determined if the weight of that first synapse is greater than or equal to the minimum value for this cluster and less than or equal to the maximum value in this cluster (355). If the weight value of the synapse falls within the range of the cluster, then at 360 the weight of this synapse is replaced with the average weight value that was calculated for this particular cluster. If the synapse weight is not in the weight range for this cluster, i.e., the “No” branch of either operation 350 or 355 was executed, then it is determined if it is the last synapse for this particular cluster at 370. If it is not, the next synapse for this cluster is retrieved at 375, and operations 350 and 355 are repeated. If it is the last synapse for this cluster, then it is determined at 380 whether this is the last cluster. If it is not, the next cluster is retrieved (385) and operations 345, 350, and 355 are executed for the new cluster and the synapses in the new cluster. If it is the last cluster, the process terminates.

After the execution of the operations in FIG. 3, a neural network with a revised architecture similar to FIG. 2 results. The revised neural network is then executed, and the accuracy of this revised neural network is compared with the accuracy of the neural network that was saved in operation 310. If the accuracy of the revised network has not depreciated to an unacceptable degree, the revised neural network can be put into service.

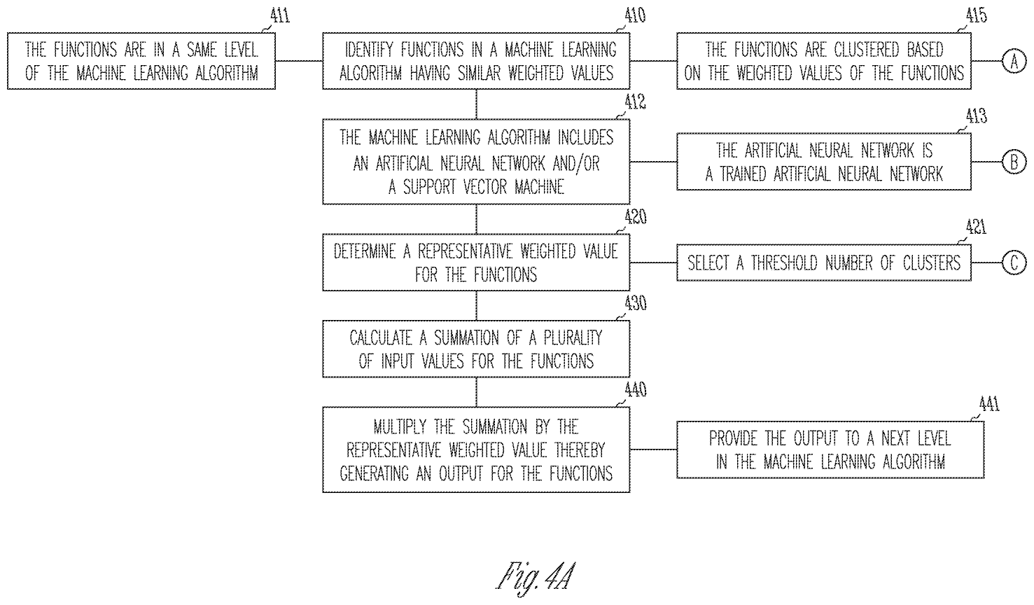

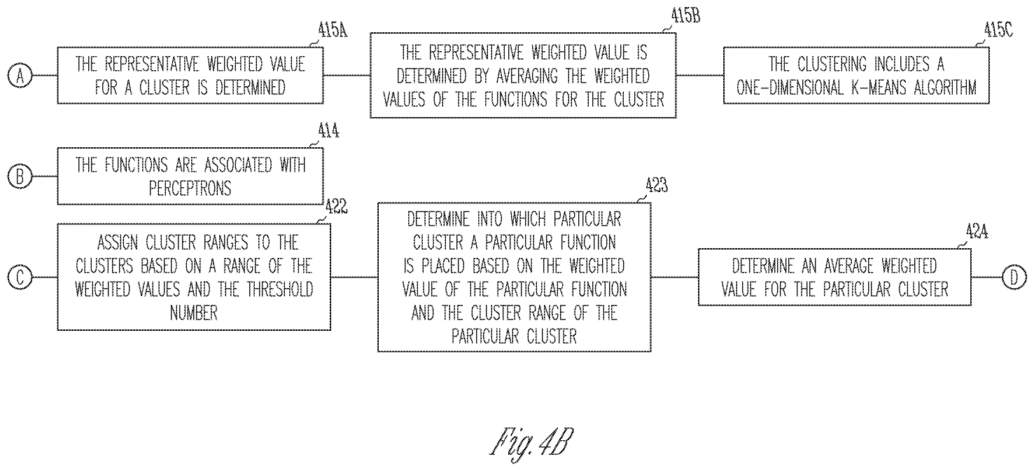

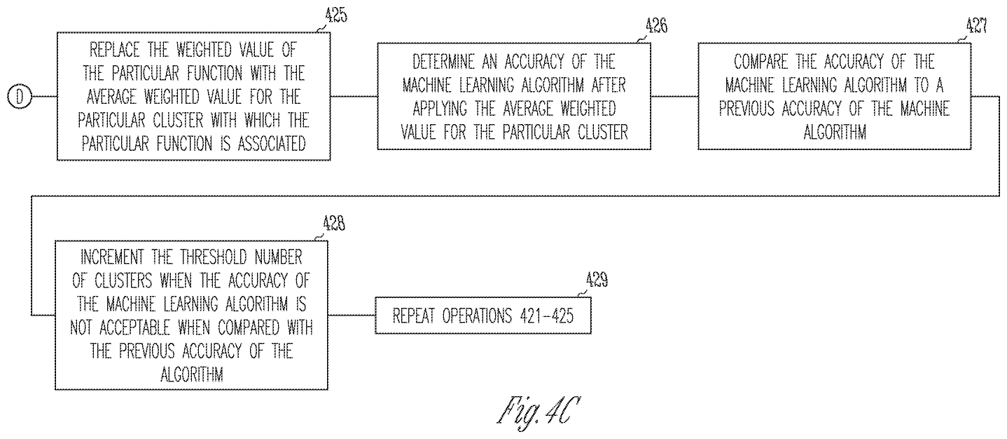

Referring now to FIG. 4, which is a block diagram illustrating another embodiment of operations and features of machine learning consolidation, at 410, functions in a machine learning algorithm are identified that include similar weighted values. At 420, a representative weighted value is determined for the functions. In an embodiment, the functions are in a same level of the machine learning algorithm (411). The machine learning algorithm can include one or more of an artificial neural network and a support vector machine (412). In an embodiment, the artificial neural network is a trained artificial neural network (413), and the functions are associated with perceptrons (414).

At a high level, the identification of functions in the machine learning algorithm that have similar weighted values is determined as follows. At 415, the functions are clustered based on the weighted values of the functions, and at 415A, the representative weighted value for a cluster is determined. The representative weighted value can be determined by averaging the weighted values of the functions for the cluster (415B). The clustering can include a one-dimensional k-means algorithm (415C).

At a more detailed level, and as also illustrated in FIG. 3, the process of identifying functions in the machine learning algorithm that include similar weighted values and determining a representative weighted value for the functions involves the following. At 421, a threshold number of clusters is selected. As discussed above in connection with FIG. 3, in an embodiment, the system begins with two clusters, and if the selection of two clusters results in a system that unacceptably degrades the accuracy of the machine learning algorithm, the process is repeated with increasing numbers of clusters until a threshold number of clusters results in a system with an acceptable accuracy. In an embodiment, an unacceptable degradation in the accuracy of the machine learning algorithm may be where the accuracy of the machine learning algorithm differs by more than 5% from a previous accuracy of the machine learning algorithm.

At 422, the clusters are assigned cluster ranges based on a range of the weighted values and the threshold number. For example, if the weighted values range from −1.0 to 1.0, and the system is on its fourth iteration, there would be five clusters and the ranges for the five clusters could be −1.0 to −0.7 for the first cluster, −0.6 to −0.3 for the second cluster, −0.2 to 0.1 for the third cluster, 0.2 to 0.5 for the fourth cluster, and 0.6 to 1.0 for the fifth cluster. At 423, it is determined into which particular cluster a particular function is placed based on the weighted value of the particular function and the cluster range of the particular cluster. Using the example, if the particular function has a weight of 0.7, it would be placed into the fifth cluster. At 424, an average weighted value is determined for the particular cluster. In an embodiment, this average weighted value is a simple arithmetic average. At 425, the weighted value of the particular function is replaced with the average weighted value for the particular cluster with which the particular function is associated.

After the execution of operations 421-425, the accuracy of the machine learning algorithm is determined (426). Then, at 427, the accuracy of the machine learning algorithm is compared to a previous accuracy of the machine algorithm. At 428, the threshold number of clusters is incremented when the accuracy of the machine learning algorithm is not acceptable when compared with the previous accuracy of the algorithm. Then, at 429, the system repeats operations 421-425, that is, assigning cluster ranges to the clusters based on the range of the weighted values and the threshold number, determining a particular cluster into which a particular function is associated based on the weighted value of the particular function and the cluster range, determining an average weighted value for the particular cluster, and replacing the weighted value of the particular function with the average weighted value for the particular cluster.

At 430, a summation of a plurality of input values for the functions is calculated, and at 440, the summation is multiplied by the representative weighted value. This multiplication generates an output for the functions, which at 441 can be provided to a next level in the machine learning algorithm.

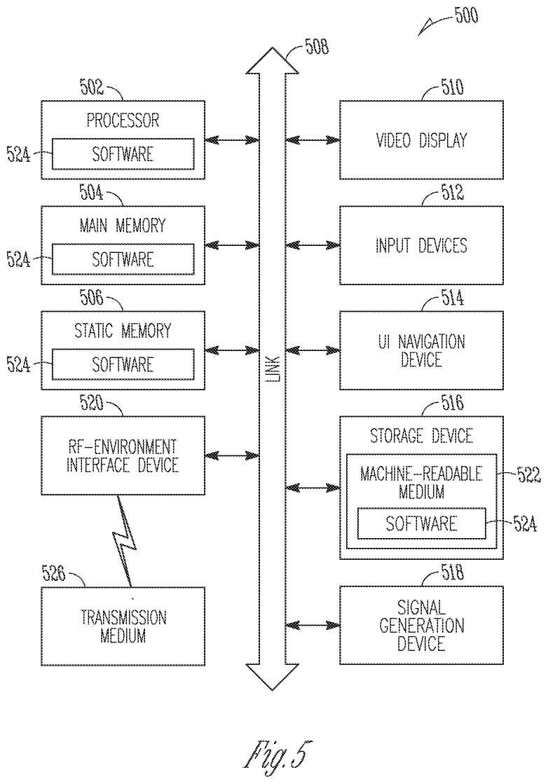

FIG. 5 is a block diagram illustrating a computing and communications platform 500 in the example form of a general-purpose machine on which some or all the features and operations of FIGS. 3, 4A, 4B, and 4C may be carried out according to various embodiments. In certain embodiments, programming of the computing platform 500 according to one or more particular algorithms produces a special-purpose machine upon execution of that programming. In a networked deployment, the computing platform 500 may operate in the capacity of either a server or a client machine in server-client network environments, or it may act as a peer machine in peer-to-peer (or distributed) network environments.

Example computing platform 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computing platform 500 may further include a video display unit 510, input devices 512 (e.g., a keyboard, camera, microphone), and a user interface (UI) navigation device 514 (e.g., mouse, touchscreen). The computing platform 300 may additionally include a storage device 516 (e.g., a drive unit), a signal generation device 518 (e.g., a speaker), and a RF-environment interface device (RFEID) 520.

The storage device 516 includes a non-transitory machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computing platform 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

RFEID 520 includes radio receiver circuitry, along with analog-to-digital conversion circuitry, and interface circuitry to communicate via link 508 according to various embodiments. Various form factors are contemplated for RFEID 520. For instance, RFEID may be in the form of a wideband radio receiver, or scanning radio receiver, that interfaces with processor 502 via link 508. In one example, link 508 includes a PCI Express (PCIe) bus, including a slot into which the NIC form-factor may removably engage. In another embodiment, RFEID 520 includes circuitry laid out on a motherboard together with local link circuitry, processor interface circuitry, other input/output circuitry, memory circuitry, storage device and peripheral controller circuitry, and the like. In another embodiment, RFEID 520 is a peripheral that interfaces with link 508 via a peripheral input/output port such as a universal serial bus (USB) port. RFEID 520 receives RF emissions over wireless transmission medium 526. RFEID 520 may be constructed to receive RADAR signaling, radio communications signaling, unintentional emissions, or some combination of such emissions.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A process comprising:
identifying functions in a machine learning algorithm that comprise similar weighted values;
determining a representative weighted value for the functions;
calculating a summation of a plurality of input values for the functions; and
multiplying the summation by the representative weighted value, thereby generating an output for the functions.

2. The process of claim 1, wherein the functions are in a same level of the machine learning algorithm.

3. The process of claim 1, wherein the machine learning algorithm comprises one or more of an artificial neural network and a support vector machine.

4. The process of claim 3, wherein the artificial neural network comprises a trained artificial neural network.

5. The process of claim 3, wherein the functions are associated with perceptrons.

6. The process of claim 1, comprising providing the output to a next level in the machine learning algorithm.

7. The process of claim 1, wherein the identifying functions in the machine learning algorithm that comprise similar weighted values comprises clustering the functions based on the weighted values of the functions.

8. The process of claim 7, wherein the clustering comprises a one-dimensional k-means algorithm.

9. The process of claim 7, wherein the representative weighted value is determined by averaging the weighted values of the functions for the cluster.

10. The process of claim 1, comprising checking an accuracy of the machine learning algorithm after the multiplying the summation by the representative weighted value.

11. The process of claim 1, wherein the identifying functions in the machine learning algorithm that comprise similar weighted values and the determining a representative weighted value for the functions comprise:
selecting a threshold number of clusters;
assigning cluster ranges to the clusters based on a range of the weighted values and the threshold number;
determining a particular cluster with which a particular function is associated based on the weighted value of the particular function and the cluster range of the particular cluster;
determining an average weighted value for the particular cluster; and
replacing the weighted value of the particular function with the average weighted value for the particular cluster.

12. The process of claim 11, comprising:
determining an accuracy of the machine learning algorithm after replacing the weighted value of the particular function with the average weighted value for the particular cluster;
comparing the accuracy of the machine learning algorithm to a previous accuracy of the machine learning algorithm;
incrementing the threshold number of clusters when the accuracy of the machine learning algorithm transgresses a threshold; and
repeating the assigning cluster ranges to the clusters based on a range of the weighted values and the threshold number, the determining a particular cluster into which a particular function is associated based on the weighted value of the particular function and the range, the determining an average weighted value for the particular cluster, and the replacing the weighted value of the particular function with the average weighted value for the particular cluster.

13. A non-transitory machine-readable medium comprising instructions that when executed by a processor execute a process comprising:
identifying functions in a machine learning algorithm that comprise similar weighted values;
determining a representative weighted value for the functions;
calculating a summation of a plurality of input values for the functions; and
multiplying the summation by the representative weighted value, thereby generating an output for the functions.

14. The non-transitory machine-readable medium of claim 13, wherein the machine learning algorithm comprises one or more of an artificial neural network and a support vector machine; wherein the artificial neural network comprises a trained artificial neural network; wherein the functions are associated with perceptrons.

15. The non-transitory machine-readable medium of claim 13, wherein the identifying functions in the machine learning algorithm that comprise similar weighted values comprises clustering the functions based on the weighted values of the functions; wherein the clustering comprises a one-dimensional k-means algorithm; and wherein the representative weighted value is determined by averaging the weighted values of the functions for the cluster.

16. The non-transitory machine-readable medium of claim 13, wherein the identifying functions in the machine learning algorithm that comprise similar weighted values and the determining a representative weighted value for the functions comprise instructions for:
selecting a threshold number of clusters;
assigning cluster ranges to the clusters based on a range of the weighted values and the threshold number;
determining a particular cluster with which a particular function is associated based on the weighted value of the particular function and the cluster range of the particular cluster;
determining an average weighted value for the particular cluster; and
replacing the weighted value of the particular function with the average weighted value for the particular cluster.

17. The non-transitory machine-readable medium of claim 16, comprising instructions for:
determining an accuracy of the machine learning algorithm after replacing the weighted value of the particular function with the average weighted value for the particular cluster;
comparing the accuracy of the machine learning algorithm to a previous accuracy of the machine learning algorithm;
incrementing the threshold number of clusters when the accuracy of the machine learning algorithm transgresses a threshold; and
repeating the assigning cluster ranges to the clusters based on a range of the weighted values and the threshold number, the determining a particular cluster into which a particular function is associated based on the weighted value of the particular function and the range, the determining an average weighted value for the particular cluster, and the replacing the weighted value of the particular function with the average weighted value for the particular cluster.

18. A system comprising:
a computer processor; and
a computer memory coupled to the computer processor;
wherein the computer processor and computer memory are operable for:
identifying functions in a machine learning algorithm that comprise similar weighted values;
determining a representative weighted value for the functions;
calculating a summation of a plurality of input values for the functions; and
multiplying the summation by the representative weighted value, thereby generating an output for the functions.

19. The system of claim 18, wherein the computer processor and computer memory are operable for:
selecting a threshold number of clusters;
assigning cluster ranges to the clusters based on a range of the weighted values and the threshold number;
determining a particular cluster with which a particular function is associated based on the weighted value of the particular function and the cluster range of the particular cluster;
determining an average weighted value for the particular cluster; and
replacing the weighted value of the particular function with the average weighted value for the particular cluster.

20. The system of claim 19, wherein the computer processor and the computer memory are operable for:
determining an accuracy of the machine learning algorithm after replacing the weighted value of the particular function with the average weighted value for the particular cluster;
comparing the accuracy of the machine learning algorithm to a previous accuracy of the machine learning algorithm;
incrementing the threshold number of clusters when the accuracy of the machine learning algorithm transgresses a threshold; and
repeating the assigning cluster ranges to the clusters based on a range of the weighted values and the threshold number, the determining a particular cluster into which a particular function is associated based on the weighted value of the particular function and the range, the determining an average weighted value for the particular cluster, and the replacing the weighted value of the particular function with the average weighted value for the particular cluster.
